(19) United States
(12) Patent Application Publication
(10) Pub. No.: US 2006/0108195 A1
(43) Pub. Date: May 25, 2006

(54) ROTATIVE COIN-OPERATED LOCK FOR INTERLOCKING SUPERMARKET TROLLEYS

(76) Inventor: Javier Valdes De La Garza, Torreon (MX)

Correspondence Address: JAVIER VALDES DE LA GARZA, CENTRAL 302 T. JARDIN, TORREON, 27200, MX

(21) Appl. No.: 10/905,167

(22) Filed: Dec. 20, 2004

(30) Foreign Application Priority Data
Nov. 22, 2004 (MX) NL/A/2004/000095

(51) Int. Cl. G07F 5/00; G07F 17/00; G07F 11/00; G07F 13/00; G07F 15/00

(52) U.S. Cl. 194/247

(57) ABSTRACT

A coin-operated locking device for interlocking two or more supermarket trolleys stored in a row, where each trolley has one unit of the lock attached to the side of the trolley. A chain is attached to the trolley frame, where said chain has a key in the free end to be inserted and secured by the lock of the next trolley in the row but not in the lock attached to the same trolley. The device has two orifices, one for inserting a coin and another one where said key is inserted and secured. To release this key the user must insert a coin into the locking device and turn one lever. This rotative motion will trap the coin inside the lock while freeing the key. An internal mechanism will lock the mechanism rotation, and the access to the coin, until the key is inserted again.

### BACKGROUND OF THE INVENTION

This invention relates to a coin-operated lock for interlocking supermarket trolleys stored in queues, rows or stacks.

Supermarkets have trolleys available for customers to transport merchandise. Customers are usually allowed to take the trolleys outside the supermarket and into the parking lot. Once the customer has finished, he is expected to return the trolley to its designated place, usually where he took it in the first place, but this seldom happens; trolleys end up abandoned all over the parking area and in different places around the store, forcing the supermarket to recollect and stack them in place.

This problem has been solved in the past, mainly in European countries, by attaching a coin-operated lock in each trolley. When the customer arrives at a supermarket and needs a trolley, he must insert a coin into the trolleys' lock in order to release a chain, which is attached to the next trolley in the stack. Once the trolley is free, the coin will not be returned by the lock until the customer returns the trolley to its designated place and secures the chain of the following trolley in the row. This is a way to encourage customers to return the trolleys to the designated areas.

The coin-operated locks currently in use have mechanisms of horizontal operation and in most cases automatic; the user only needs to introduce the coin in order to release the chain. This involves an elevated number of internal parts of complex geometry and tight manufacturing tolerances, which increments the cost and assembly time. Also, due to their external dimensions and shape, said locks can be mounted only in the trolleys' handle bar, making them useless in the vast majority of trolleys used in America. The reason for this problem is the distance between the trolleys handles when stacked is approximately three times bigger in America than in Europe. Having a bigger distance means a longer chain, which in turn would make it possible for the chain to be inserted in the lock attached to the same trolley, making the purpose of the lock useless.

### BRIEF SUMMARY OF THE INVENTION

The main object of this invention is to provide a coin-operated lock for interlocking trolleys stored in a row based upon a novel rotative mechanism operated by the user to open or close said lock. This rotative function and the manual operation considerably reduce the number and complexity of its component parts compared to the existing coin-operated locks.

Another object of the invention is to provide a locking device as mentioned above, in which the array of the internal components gives the said lock a geometry of very narrow thickness, which in turn allows the lock to be positioned on one side of the trolley instead of the handle bar. This solves the problem, which existing coin-operated locks have, related to the distance between handle bars when stacked.

Another object of the invention is to provide a coin-operated locking device as mentioned above, in which the array of the internal components gives the said lock an anti-thief function as it will be explained in detail later.

Other objects of the invention will become apparent from the following description.

In summary, this invention refers to a coin-operated locking device for interlocking two or more supermarket trolleys stored in a row, where each trolley has one unit of the lock attached to the side of the trolley. It also consists of one chain attached to the trolley frame, where said chain has a key in the free end to be inserted into and secured by the lock of the next trolley in the row, but is not possible into the lock attached to the same trolley.

Said locking device has one opening for inserting a coin. In the opposite end it has another opening where the key attached to the chain of the next trolley is inserted and secured. To release this key the user must insert a coin into the locking device and turn one lever in said lock. This rotative motion will trap the coin inside the lock while freeing the key on the other side. An internal mechanism will lock the mechanism rotation and the access to the coin until the key is inserted again.

### BRIEF DESCRIPTION OF THE DRAWINGS

FIG. 1 is a lateral view of queued trolleys using the rotative coin-operated lock and the chain used to interlock them.

FIG. 2 is a perspective view showing the rotative coin-operated lock, part of the chain, the coin, and the key.

FIG. 3 is a perspective view showing the rotative coin-operated lock rear and the method used to attach it to the trolley.

FIG. 4 is an exploded perspective view of the components of the rotative coin-operated lock.

FIG. 5 is a perspective view showing the chain and the way it is attached to the trolley.

FIG. 6 is a front sectional view showing the internal parts of the rotative coin-operated lock in the “locked” position.

FIG. 7 is a front sectional view showing the internal parts of the rotative coin-operated lock in the “open” position.

FIG. 8 is a front sectional view showing the internal parts of the rotative coin-operated lock in the “locked-limit” position. This position is present when the device is tried to be opened without using a coin.

FIG. 9 is a front sectional view showing the internal parts of the rotative coin-operated lock in the “open-stop” position. This position is present when the lock has been tried to be opened with something different than the key.

FIG. 10 is a sectional view taken on line X-X of FIG. 6 showing the locking mechanism in its “locked” position.

### DETAILED DESCRIPTION OF THE INVENTION

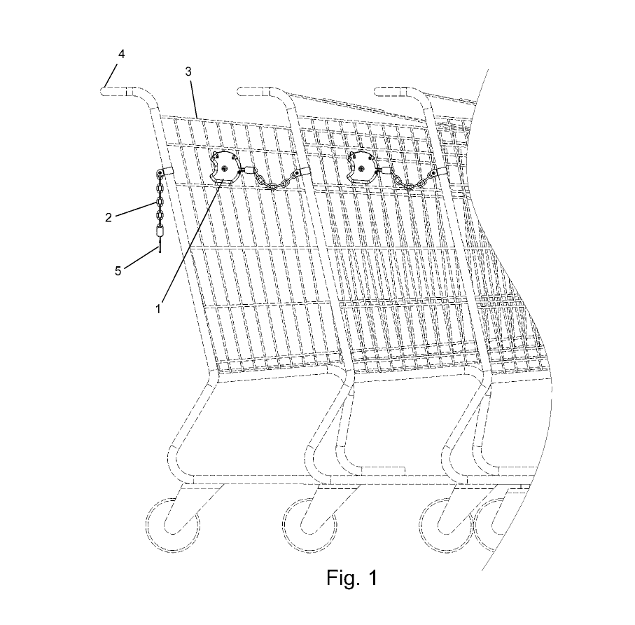

Referring to FIG. 1 is shown how the rotative coin-operated lock 1 is placed on the side of the trolley 3 at an intermediate distance between the nearest horizontal ends of the trolley and the following trolley when queued. This way the only key 5 available for insertion is the one belonging to the following trolley and not the one attached to the same trolley. This solves the problem of current coin-operated locks which can not be used when the distance between the trolleys handle bars is too large, as can be seen in the vast majority of trolleys used in America. The reason for this problem is, under these circumstances, that the chain would be long enough to be used in the lock situated in the same trolley, making it useless.

The lock 1 is attached to side of the trolley 3 as is shown in FIG. 3 using a metal plate 14 and four blind rivets 15 around one of the vertical rods 17 of the trolley 3 frame. Said rivets are inserted into four holes of the lock back body 18. This method for attaching the lock 1 to the trolley 3 is simple, strong, and economic. It also allows the lock 1 to be attached to different types of trolleys, e.g. made of plastic, changing only the metal plate 14 for a different one.

On FIG. 5 is shown how the chain 2 is attached to the trolley 3. For this purpose a metallic band 37 is placed around the frame of the trolley 3 and is closed using a screw or rivet. Its position can be seen in FIGS. 1 and 5. Another option for attaching the chain 2 to the trolley 3 could be welding it directly to the trolley frame but this would make it difficult to replace the chain if necessary.

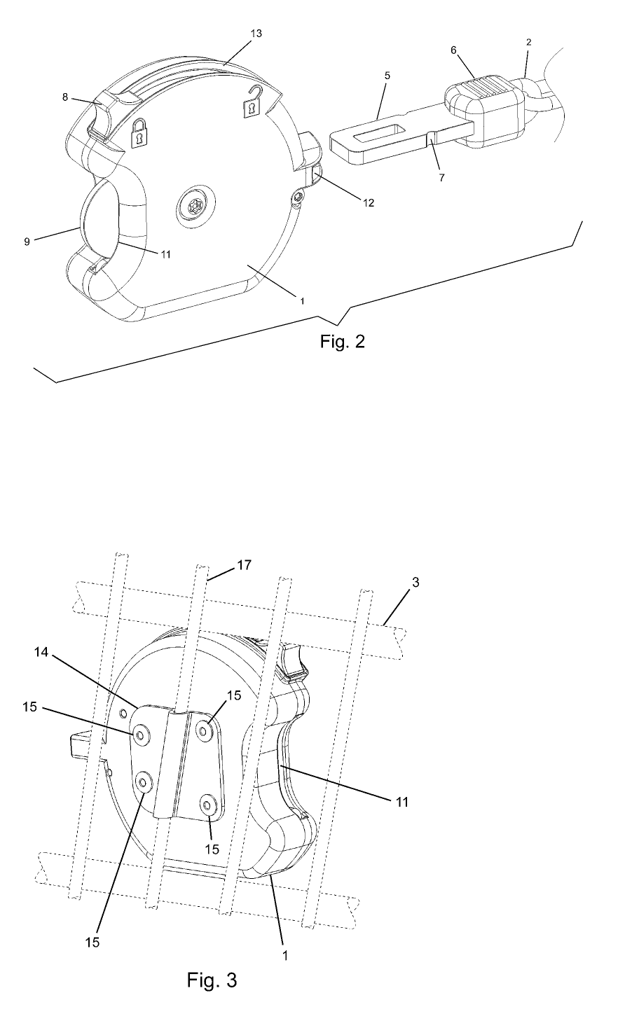

The rotative coin-operated lock 1, as shown in FIG. 2, has one orifice 11 to insert a coin 9 and another orifice 12 at the other end for insertion of the key 5. On its top there is a channel 13 where the lever 8 travels from one end to the other, operated by the user, to open or close the locking mechanism and trap the coin 9.

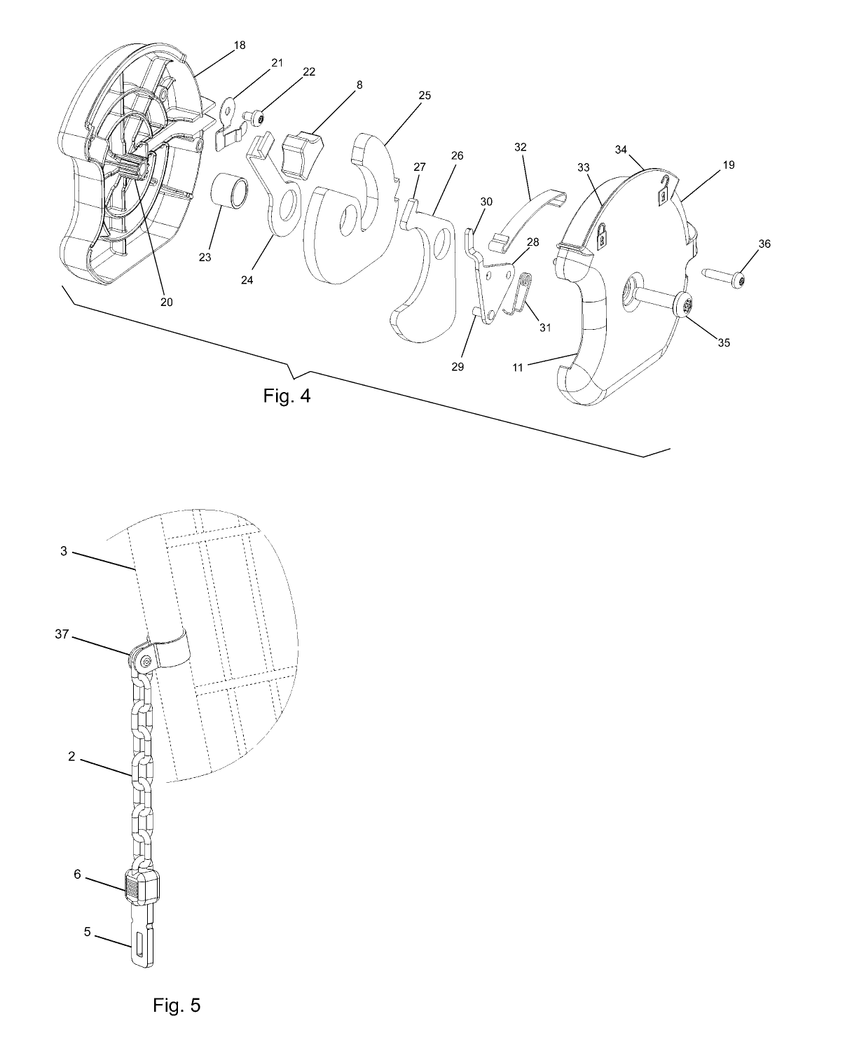

The lock 1 body is made of two halves, the back body 18 and the front cover 19, shown in FIG. 4. These two parts are made of zinc or magnesium die cast; the use of plastic material is permissible as long it has properties similar to the metals. Said parts have internal ribs to increase strength and guide the mechanisms in their motion and are assembled together using a main self-screwing screw 35 and a smaller self-screwing screw 36 used for reinforcing the orifice 12. This array allows the lock 1 to be serviced in the future; having full access to the internal parts just by removing two screws and the front cover 19.

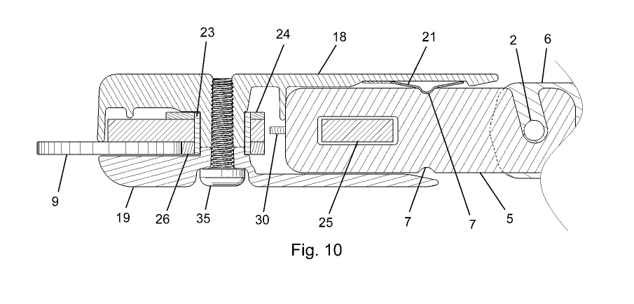

The key 5 has a shape that allows it to be inserted into the orifice 12 and has a hole where the hook-shaped plate 25 passes through. Said key, as shown in FIG. 10, is attached to the chain 2 using a hook geometry and it is covered with a key handle 6 made of plastic. Also in FIG. 10 is shown how the key 5 has a recess 7 where the flat spring 21 lies to avoid being expulsed from the lock, under the pressure of the detent arm 30, when the hook-shaped plated is in the open position.

On FIG. 4 is shown the internal components of the lock and can be seen how the mechanism rotates around an axis 20 formed by the back body 18 and the front cover 19. Over this axis a bronze spacer 23 is placed which rotates freely to reduce the wear and friction of the components. Over this bronze spacer rotates three metallic parts, welded together and acting as one part: the lever arm 24, the hook-shaped plate 25, and the coin receiver 26. The lever arm 24 transfers the position of the lever 8 to the internal mechanism. The hook-shaped plate 25 it is used for locking or releasing the key 5. The coin receiver 26 is used to receive, hold, and trap the coin inside the lock, also for stopping the rotation of the mechanism with its hook 27 when no coin has been inserted. On the same plane as this coin receiver, by the internal perimeter, a metal spring 32 is used to grab and stop the rotation of the hook 27 mentioned before. Another internal component is the metallic detent 28 which, under the pressure of a torsion spring 31, rotates on an axis to stop any rotation of the mechanism when the key 5 is pulled out of the lock. Another internal part is the flat spring 21 used to hold the key 5 in place while operating the mechanism; this spring is attached to the back body 18 using a self-screwing screw 22.

The operation of the rotative coin-operated lock can be divided into the following four main positions:

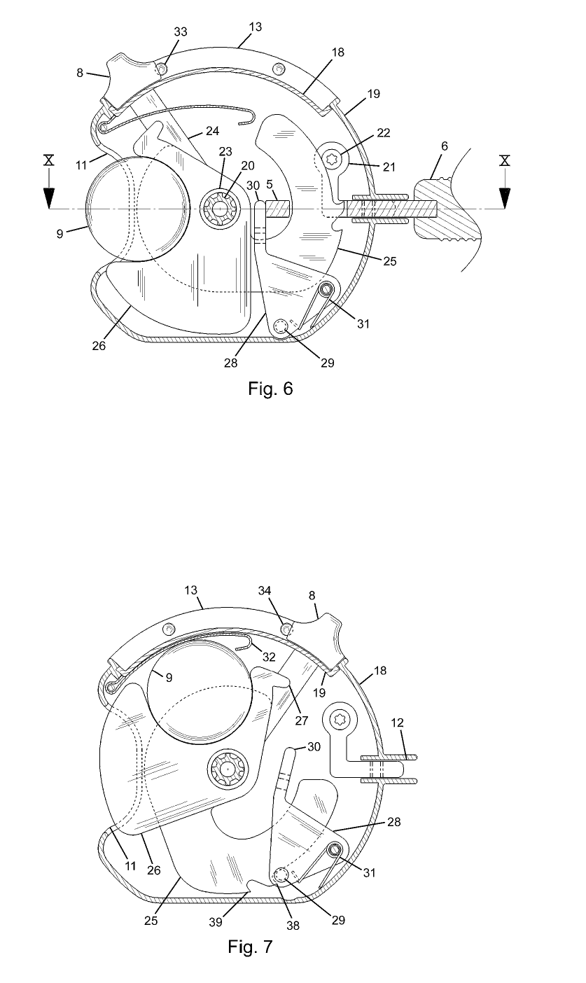

The first position, called “closed”, is shown in FIG. 6. This position is present when the lock is closed and the key 5 is secured inside the lock 1; the trolley can not be taken away from the queue line. As shown in FIG. 6, the lever 8 is on the left side at the end of the travel channel 13 and a bump 33, formed in the front cover 19, is used for holding it in place. The coin receiver 26 is aligned with the orifice 11 and ready for receiving the coin 9. The key 5, secured by the hook-shaped plate 25, is positioned on its place by a flat spring 21. Also, said key 5 is pushing the detents arm 30 in a counter clockwise direction to keep the detents pin 29 out of the hook-shaped plate 25 travel motion.

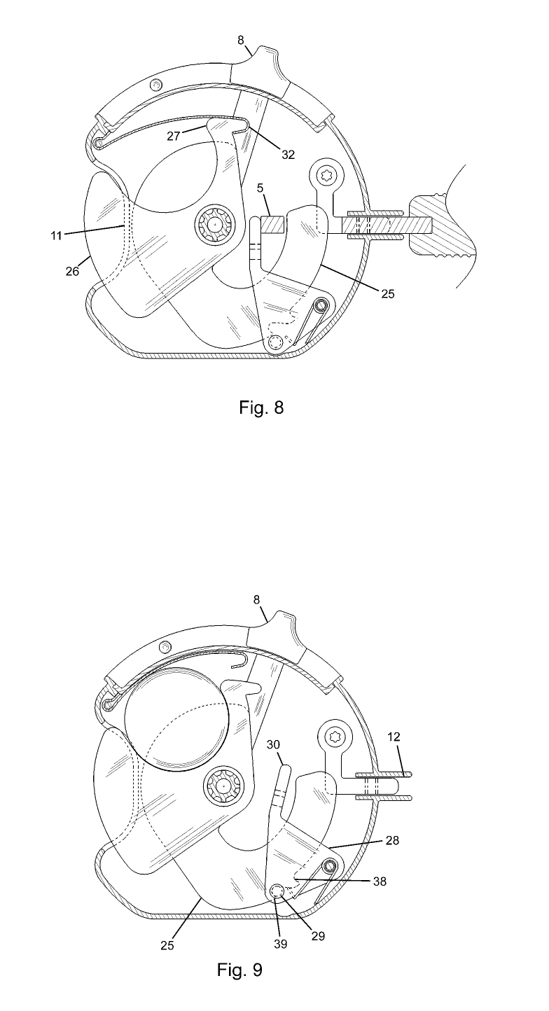

The second position, called “open”, is shown in FIG. 7. This position is present when the user has inserted a coin through the orifice 11 and turned the lever 8 all the way to the other end of the travel channel 13. With this action the lock is opened and the key 5 is free to be removed through the orifice 12; the trolley is ready to be used. As a result of the displacement of the lever 8 from one side to the other, the following changes can be seen: a bump 34 formed in the front cover 19 keeps the lever in the open position. The coin 9, forced by the rotation of the coin receiver 26, rotates and pushes the stopper spring 32 away from the travel motion of the coin receiver's hook 27. The coin receiver 26 fills the orifice 11 avoiding the entrance of another coin or foreign object. The hook-shaped plate 25 has released the key 5, which is removed from the lock by the user, allowing the clockwise rotation of the detent 28 which is under the pressure of the torsion spring 31. The detent pin 29 now lays at the edge of the hook-shaped plate 25 at its first notch 38, locking the mechanism from any further rotation; the coin is trapped inside the lock. This situation remains until the trolley is returned to the queue and the key 5 of the following trolley is inserted. Said key pushes the detents arm 30 and forces the detent 28 into a counter clockwise motion, which takes the detents pin 29 out of the hook-shaped plate 25 travel motion. The lever 8 is free to travel to the opposite end of the travel channel 13 and the lock returns to the “closed” position described before.

The third position, called “closed-limit”, is shown in FIG. 8. This position is present when the user tries to open the lock without using a coin. Pushing the lever 8 from one side to the other, the coin receiver hook 27 rotates and meets the stopper spring 32, blocking any further rotation. The hook-shaped plate 25 rotation is not enough to release the key 5; the lock remains closed and attached to the next trolley in the queue. The coin receiver 26 has rotated enough to fill the orifice 11 making the tampering of the lock through said orifice more difficult.

The fourth position, called “open-limit”, is shown in FIGS. 7 and 9. Having the lock in the “open” position, as shown in FIG. 7, makes it possible for a thief to try to steal the coin 9 using some device different than the key 5, for example a car key. The thief inserts the car key into the opening 12 and pushes the detent arm 30 to release the detent pin 29 from the notch 38, allowing the rotation of the mechanism. When the lever 8 is pushed in a counter clockwise direction in order to close the lock and receive the coin 9, the hook-shaped plate 25 rotates and finds the thief car key in its way. The thief is forced to remove the car key outside the lock in order to allow the hook-shaped plate 25 to continue its circular motion and notices, as shown in FIG. 9, how the rotation is stopped again by the detent pin 29 engagement into a second notch 39 at the edge of the hook-shaped plate 25. This array of parts is shown in detail in FIG. 10, where can be seen how the detent arm 30 is in the same plane and behind the hook-shaped plate 25, protecting it from being pushed by strange objects. The hook-shaped plate notches 38 and 39 have a geometry that blocks the rotation in one way and allows it in the other, this way the user can return the lever 8 to the open position after the burglar's attempt.

As various changes could be made in the above constructions and uses without departing from the scope of the invention, it is intended that all matter contained in the above description or shown in the accompanying drawings shall be interpreted as illustrative and not in a limiting sense.

What is claimed is:

1. A coin controlled locking device for interlocking two or more nested trolleys, the device including: a body having two parts, one attached to the side of the trolley and the other acting as a cover where both parts are screwed together to form an axis in its center where a mechanism rotates, an orifice in one end of the body to receive a coin, an orifice in the opposite side to receive a key, a lever to rotate the mechanism from the open position to the closed position and vice versa, a key attached to one end of a chain where the other end is attached to the frame of the trolley in such location where the key can be inserted on the locking device of the next trolley but not to the locking device installed on the same trolley, a coin plate to receive and trap the coin which rotates around the said axis upon rotation of the said lever, a hook-shaped plate attached to the said coin plate which rotates around the said axis upon rotation of the said lever to lock or unlock an orifice on the key inserted into the device and belonging to the next trolley, a spring with a hook on one end to stop the rotation of the said coin plate when no coin has been inserted into the device otherwise said spring is pushed away from the coin plate travel when a coin is inserted and rotated allowing the free rotation of the mechanism, a bronze cylinder placed over the said axis to reduce the friction and wear caused by the rotation of the internal components, a detent which rotates clockwise on its own axis by the action of an axial spring to lock a notch of the said hook-shaped plate when the said key is removed from the locking device and with this action stopping the rotation of the mechanism keeping the coin inside the locking device until the said key is inserted again and pushes one arm of the said detent to make it rotate counter clockwise to free the said notch, a flat spring to press a notch formed on the key edge to keep it in its internal position temporally while is under the pressure of the said detents arm.

2. A coin controlled locking device according to claim 1 in which the hook of the said hook-shaped plate is placed between and in the same plane of the said detents arm and the orifice used to introduce the key to protect the said detents arm from being pushed by a foreign object different from the key, also for this purpose the said hook-shaped plate has a second notch to lock the rotation of the mechanism in combination with the said detent, where the said notch has a geometry which allows the rotation of the mechanism in one direction and locking it in the other.

3. A coin controlled locking device according to claim 1 in which the said arm of the lever, the said hook-shaped plate and the said coin receiver are one part made of die-cast metal or similar process.

4. A coin controlled locking device according to claim 1 in which the said spring with a hook function can be replaced by a part of similar geometry having in one end an axis where it rotates and in the other end a hook, where this part can be made of die-cast metal or similar process and has a spring pressing it again the said coin receiver.
